(19) United States
(12) Patent Application Publication
(10) Pub. No.: US 2023/0292801 A1
(43) Pub. Date: Sep. 21, 2023

(54) CRYSTALLINE SUGAR COMPOSITE POWDER AND METHODS FOR MAKING THE SAME

(71) Applicant: Kerry Group Services International Limited, Tralee (IE)

(72) Inventors: Vikash MALIK, Middleton, WI (US); Li PAN, Rockton, IL (US); Rajesh POTINENI, South Beloit, IL (US); Elizabeth Norris SHARP, Roscoe, IL (US); Jack MAEGLI, Beloit, WI (US); Peter Yongjae LEE, Middleton, WI (US); Elizabeth GERSTER, Milwaukee, WI (US); Madeline WASKIEWICZ, Beloit, WI (US); Alex RIESCHE, Rockton, IL (US)

(73) Assignee: Kerry Group Services International Limited, Tralee (IE)

(21) Appl. No.: 17/698,429

(22) Filed: Mar. 18, 2022

(51) Int. Cl. A23L 27/30; C08L 1/02; A23L 29/30; A23G 1/40

(52) U.S. Cl. CPC A23L 27/33; C08L 1/02; A23L 29/30; A23G 1/40; C07B 2200/13; A23V 2002/00

(57) ABSTRACT

A crystalline sugar composite powder and methods for making the same. A crystalline sugar composite powder used as a sugar substitute ingredient. A crystalline sugar composite powder including crystalline sugar particles, and sugar composite particles, the sugar composite particles including cellulose fiber and a plurality of sugar crystals formed on a surface of the cellulose fiber. A process of preparing a crystalline sugar composite powder by a solvent inversion process as disclosed. A food or beverage including the crystalline sugar composite powder.

### FIELD OF THE DISCLOSURE

The present disclosure relates generally to a crystalline sugar composite powder and methods for making the same. The crystalline sugar composite powder may be used, for example, as a sugar substitute ingredient having a morphology that is interpreted upon consumption as having, for example, a higher level of sweetness and/or a lingering sweetness, thereby allowing a lower level of sugar.

### BACKGROUND OF THE DISCLOSURE

The consumption of sugar continues to increase, and there is a global incentive to reduce the amount of sugar consumed. Further, there is a global incentive to substitute sugar with a natural, sustainable alternative, rather than synthetic or artificial sweeteners.

In the past, some methods of crystallization of sugar have been reported but none of those have described the application of crystallized sugar in food applications. For example, these methods have included crystallization by solvent inversion such as alcohol. However, that type of method produces homogenous nucleation that in turn creates uniform size sugar crystals. In addition, there is no literature on the use of crystalline sugar produced using this method.

There remains a need for a method for making crystallized sugar that is applicable and suitable for sugar reduction purposes.

### SUMMARY OF THE DISCLOSURE

In one aspect of an example embodiment, the disclosure provides a crystalline sugar composite powder, including both (a) crystalline sugar particles, and (b) sugar composite particles, where the crystalline sugar particles may consist essentially of a sugar, and may have a “first” average particle size; where each of the sugar composite particles may consist essentially of cellulose fiber and a plurality of sugar crystals that are formed on a surface of the cellulose fiber, the plurality of sugar crystals may consist essentially of the sugar, and the sugar composite particles have a “second” average particle size; and where the first average particle size of the crystalline sugar particles may be smaller than the second average particle size of the sugar composite particles.

The crystalline sugar composite powder of the present disclosure is derived from the use of cellulose fiber as a nucleation agent, which not only helps in enhancing the nucleation and growth of sugar crystals, but also produces heterogenous sugar crystals, thereby providing a composite powder that is surprisingly useful for sugar reduction purposes.

In another aspect of the crystalline sugar composite powder, the cellulose fiber of the sugar composite particles is insoluble. This means that the cellulose fibers may be 100% insoluble in water and in common organic solvents, but form a dispersed colloidal suspension with minimum agitation. The insolubility of cellulose fiber allows the cellulose fiber to function as an agent for nucleation and growth of sugar crystals, as explained in more detail below. In some aspects, a solubility of the cellulose fiber in water at 25° C. may be, for example, at least less than about 10 mg/L.

In another aspect of the crystalline sugar composite powder, the average particle size of the crystalline sugar composite powder may be, for example, about 10 μm to about 250 μm. In some aspects, the average particle size of the powder may be, for example, about 12 μm to about 236 μm, or about 12 μm to about 226 μm.

In another aspect of the crystalline sugar composite powder, the sugar may be sucrose, and in some aspects, the sucrose is obtained from common, granulated sugar.

In another aspect of the crystalline sugar composite powder, the second average particle size of the sugar composite particles may be, for example, about 1 to about 500 μm. In some aspects, the second average particle size may be, for example, about 5 μm to about 500 μm, may be about 1 μm to 100 μm, may be about 100 μm to about 400 μm, or may be about 200 μm to about 300 μm.

In another aspect, the first average particle size of the crystalline sugar particles may be, for example, about 0.5 μm to about 100 μm. In some aspects, the first average particles size may be, for example, about 5 μm to about 90 μm, may be about 15 μm to about 75 μm, or may be about 30 μm to about 60 μm.

In another aspect of the crystalline sugar composite powder, the crystalline sugar particles may consist of the sugar.

In another aspect of the crystalline sugar composite powder, the cellulose fiber may be obtained, for example, from coffee beans, corn stalk, rice hull, wheat chaff, cauliflower floret, cauliflower stem, pea hull, soybean hull, cocoa hull, cabbage leaf, rice bran, corn bran, wheat bran, oat bran barley bran, rye bran, millet bran, or any combination thereof.

In another aspect of the crystalline sugar composite powder, the cellulose fiber is natural cellulose fibers extracted from one or more of, for example, cereals, cabbage, fruits, legumes, nuts, grains, potatoes, and seeds.

In another aspect of the crystalline sugar composite powder, the cellulose fibers may include, for example, lignin fibers, hemicellulose fibers, and/or pectin. In some aspects, the cellulose fibers may be only lignin fibers, may be only hemicellulose fibers, or may be only pectin. In some aspects, the cellulose fibers may be include lignin and hemicellulose in any weight ratio between 1:99 to 99:1.

In another aspect of the crystalline sugar composite powder, the cellulose fibers are natural fibers having pores in the wall of the fiber.

In another aspect of the crystalline sugar composite powder, the cellulose fiber may be obtained from spend coffee grounds.

In another aspect of the crystalline sugar composite powder, the cellulose fiber may be decolored.

In another aspect of the crystalline sugar composite powder, the cellulose fiber may have an average particle size of about 10 μm to about 120 μm. In some aspects, the average particles size of the cellulose fiber may be about 21 μm to about 120 μm, or about 50 μm to about 100 μmm or about 70 to about 90 μm.

In another aspect of the crystalline sugar composite powder, a weight ratio of a total content of the cellulose to a total content of the sugar in the crystalline sugar composite powder may be from about 0.1:99.9 to about 20:80. In some aspects, this weight ratio may be, for example, about 0.1:99.9 to about 15:95, or about 0.1:99.9 to about 10:90, or about 0.5:99.5 to about 10:90, or about 1:99 to about 10:90, or about 1:99 to about 5:95.

In another aspect of the crystalline sugar composite powder, a moisture content of the crystalline sugar composite powder may be less than about 5% by weight. In some aspects, this moisture content may be less than about 4% by weight, or less than about 3% by weight, or less than about 2% by weight, less than about 1% by weight, or less than about 0.1% by weight.

In another aspect, a solids content of the crystalline sugar composite powder may be about 90 to about 99.9 percent by weight. In some aspects, this solids content may be about 95 to about 99%, or about 97 to about 99%.

In one aspect of an example embodiment, the disclosure provides a crystalline sugar composite powder obtained by a process that includes, for example, suspending the cellulose fiber in a nearly supersaturated aqueous solution of the sugar; reducing solubility of the sugar in the suspension with solvent inversion by mixing the suspension with a solvent having a temperature of about −10 to about 25° C. under stirring; allowing a temperature of the mixture to rise; separating resulting solids from supernatant; and drying the separated resulting solids.

In one aspect of an example embodiment, the present disclosure provides a process of preparing a crystalline sugar composite powder, the process may include suspending cellulose fiber in a nearly supersaturated aqueous solution of a sugar, the resulting suspension having a temperature of from about 5 to about 60° C.; adding a solvent having a temperature of from about −20 to about 25° C. to the resulting suspension and allowing a temperature of the resulting mixture to rise, thereby both precipitating a plurality of sugar crystals on a surface of the cellulose fiber to form a sugar composite particle, and precipitating a plurality of crystalline sugar particles; separating a supernatant from solids; and allowing the solids to dry to obtain the crystalline sugar composite powder.

In one aspect of the method of preparing a crystalline sugar composite powder, a content of the cellulose fibers in the sugar-cellulose suspension may be about 0.1 to about 20% by weight. In some aspects, the content of the cellulose fibers may be about 0.1 to about 10% by weight, or about 0.1 to about 5% by weight. 0.1 to about 5% by weight.

In one aspect of the method of preparing a crystalline sugar composite powder, the sugar may be sucrose, such as, for example, common granulated sugar.

In one aspect of the method of preparing a crystalline sugar composite powder, allowing the temperature of the resultant to rise is performed by heating the resultant at a rate of about 1 to about 5° C. per minute.

In one aspect of the method of preparing a crystalline sugar composite powder, the method may include reducing a particles size of the crystalline sugar composite powder by, for example, grinding, crushing, cutting, or the like.

In one aspect of the method of preparing a crystalline sugar composite powder, the step of allowing the solids to dry may be performed, for example, by heating the solids at temperature of about 50 to about 150° C. In some aspects, this heating temperature may be about 50 to about 125° C., or about 50 to 70° C., or about 60 to about 70° C.

In one aspect of the method of preparing a crystalline sugar composite powder the solvent may be an alcohol, such as, for example, methanol, ethanol, and/or isopropyl alcohol, or a mixed solvent of an alcohol and water.

In one aspect of an example embodiment, the present disclosure provides a food product made using the crystalline sugar composite powder as an ingredient. In some aspects, the food product is a food product where the amount of water in the product is minimal or substantially non-existent, and such food products are known in the art. In some aspects, the food product includes a baked good, a confection, an oil-based system such as chocolate, an oil-based sauces, a cream, a butter, a cookies, a granola bar, etc.

In one aspect of an example embodiment, the present disclosure provides for example, a bread, a cake, a candy, a chocolate confection, a cookie, a custard, a frosting, an icing, a frozen desert, a pie, a tart, a pastry, a pudding, a quick-bread, a granola bar, a cream, or the like, that was made using the crystalline sugar composite powder of the present disclosure as a sweetener (or full or partial substitute for granulated sugar, powder sugar, etc.) and/or contains therein or thereon the crystalline sugar composite powder of the present disclosure.

Additional features and advantages of the present disclosure are described further below. This summary section is meant merely to illustrate certain features of the disclosure and is not meant to limit the scope of the disclosure in any way. The failure to discuss a specific feature or embodiment of the disclosure, or the inclusion of one or more features in this summary section, should not be construed to limit the claims.

### BRIEF DESCRIPTION OF THE DRAWINGS

The application file contains at least one drawing executed in color. Copies of this patent application publication with color drawing(s) will be provided by the Office upon request and payment of the necessary fee.

Embodiments of the present disclosure will be more clearly understood from the following detailed description taken in conjunction with the accompanying drawings in which:

FIG. 1 is a SEM image of the crystalline sugar composite powder obtained in Example 1.

FIG. 2 is a chart showing results of chocolate sweetness relative to Reference in Example 2.

FIG. 3 is a chart showing results of chocolate sweetness degree of difference in Example 2.

FIG. 4 is a chart showing results of powder relative to Reference in Example 2.

FIG. 5 is a chart showing results of powder degree of difference in Example 2.

FIG. 6 shows images of the composite powder mixture of Example 1 (Raspberry Crystalline Sugar, 1% MFB026) and Example 3 (Raspberry Crystalline Sugar, 1% RiFiber) at 30 minutes.

FIGS. 7, 8, and 9-18 are charts and data for Example 4 dissolution comparison.

FIGS. 19-24 are charts and data for Example 5 particle size comparisons.

FIG. 25 is a chart for the Example 6 DSC comparison.

FIGS. 26 and 27 show the recreation of M. Saska Sugar in Comparative Example 2.

### DETAILED DESCRIPTION OF THE DISCLOSURE

Before the present compositions, methods, and methodologies are described in more detail, it is to be understood that the disclosure is not limited to particular compositions, methods, and experimental conditions described, as such compositions, methods, and conditions may vary. It is also to be understood that the terminology used herein is for purposes of describing particular embodiments only, and is not intended to be limiting, since scope will be limited only in the appended claims

As used in this specification and the appended claims, the singular forms “a”, “an”, and “the” include plural references unless the context clearly dictates otherwise. Thus, for example, references to “a fiber” includes one or more fibers of the type described herein, as will be apparent to those of ordinary skill in the art upon reading this disclosure and so forth.

Unless defined otherwise, all technical and scientific terms used herein have the same meaning as commonly understood by one of ordinary skill in the art to which this disclosure belongs. Any methods and materials similar or equivalent to those described herein may be used in the practice or testing of the disclosure, as it will be understood that modifications and variations are encompassed within the spirit and scope of the instant disclosure.

Unless otherwise stated, each range disclosed herein is simply a shorthand format for presenting information and will be understood to encompass and be a disclosure of each discrete point and all possible subranges within the range.

As used herein, “about,” “approximately,” “substantially,” and “significantly” will be understood by a person of ordinary skill in the art and will vary in some extent depending on the context in which they are used. If there are uses of the term which are not clear to persons of ordinary skill in the art given the context in which it is used, “about” and “approximately” will mean plus or minus <10% of particular term, and “substantially” and “significantly” will mean plus or minus >10% of the particular term.

As used herein, “comprising” and “consisting essentially of” have their customary meaning in the art.

### Crystalline Sugar Composite Powder

The present disclosure provides a crystalline sugar composite powder that includes a mixture of crystalline sugar particles with sugar composite particles. As used herein, “powder” will be understood by a person of ordinary skill in the art in the context that it is used. For example, a powder is a dry, bulk solid composed of many particles that may flow freely when shaken. The powder of the present disclosure may also be referred to as granular.

The crystalline sugar composite powder may be packaged in small quantities (such as in the well-known form of packets of table sugar (e.g., 4 gram packets)) or large quantities (such as in bulk, such as boxes, bags, etc. commonly used in the art for selling and/or transporting bulk amounts of natural and artificial sweeteners) for transportation and/or for commercial, industrial, or individual use. When packaged in any of these forms, the content within such packaging may consist essentially of the crystalline sugar composite powder or may consist of the crystalline sugar composite powder, and in either form, the crystalline sugar composite powder may consist essentially of the crystalline sugar particles and the sugar composite particles, or may consist of the crystalline sugar particles and the sugar composite particles. In other words, the present disclosure contemplates, for example, the sale and/or consumption of a composition that contains only the mixture of the crystalline sugar particles and the sugar composite particles.

As used herein, the term “dry” means that the crystalline sugar composite powder has either been subjected to a drying process (which may include, for example, any means for removing water and/or solvent from a composition including the crystalline sugar particles and the sugar composite particles) or simply allowed to dry. In this regard, the moisture content of the crystalline sugar composite powder may be less than about 5% by weight, or less than about 4% by weight, or less than about 3% by weight, or less than about 2% by weight, less than about 1% by weight, or less than about 0.1% by weight.

The melting point of the crystalline sugar composite powder may be, for example, about 160° C., which is lower than the standard melting point of sugar crystals (e.g., common granulated sugar), which is about 190° C.

The dissolution rate of 1 g the crystalline sugar composite in 9 mL of water at 28° C. may be, for example, about 6 mg/min to 42 mg/min.

### Sugar

The sugar for use in this disclosure is not particularly limited, and can be any type of natural or artificial sweetener that is suitable for use in the solvent inversion process of the present disclosure, which is discussed in more detail below. Natural sweeteners include well-known saccharides, disaccharides, and trisaccharides, which include sucrose, glucose, fructose, galactose, raffinose, maltose, lactose, and trehalose. In examples disclosed herein below, sucrose is used in the solvent inversion process to form the crystalline sugar composite powder (that is, sucrose is the sugar of the crystalline sugar particles and the sugar of the sugar crystals of the sugar composite particles).

### Salt Alternative

In an alternative embodiment of the present disclosure, the powder is not a crystalline sugar composite powder, but rather a crystalline salt composite powder, wherein each aspect of the present disclosure may be the same except that, for example, table salt (sodium chloride) is used instead of the sugar (that is, the table salt would be subjected to the solvent inversion process described below, except for using table salt instead of sugar).

### Cellulose Fiber

The cellulose fiber of the sugar composite particles is not particularly limited and can be obtained from naturally produced sources. For example, the cellulose fiber for use in the disclosure can be obtained from, for example, coffee beans, corn stalk, rice hull, wheat chaff, cauliflower floret, cauliflower stem, pea hull, soybean hull, cocoa hull, cabbage leaf, rice bran, corn bran, wheat bran, oat bran barley bran, rye bran, millet bran, cereals, cabbage, fruits, legumes, nuts, vegetables, grains, potatoes, seeds, or from any combination thereof. It is well known how to process these natural sources to obtain cellulose fibers.

In one aspect of the disclosure, the cellulose may be obtained from spend coffee grounds.

In one particular aspect, the cellulose fiber may be the “decolored and delignified water insoluble cellulose” obtained according to the processes described in U.S. Pre-Grant Publication No. 20210017299 to Li Pan et al. (hereinafter “the 299 application”), which is incorporated herein by reference in its entirety.

In another aspect of the present disclosure, the cellulose fiber may be nanocellulose. As used herein, nanocellulose is a term referring to nano-structured cellulose, which may be cellulose nanocrystals (CNC or NCC), cellulose nanofibrils (CNF) (which are also referred to in the art as cellulose nanofibers and nanofibrilated cellulose), or bacterial nanocellulose.

CNF is a material composed of nanosized cellulose fibrils typically having a high aspect ratio (length to width ratio). CNF is typically obtained a natural source of cellulose fibers, typically by a process that includes subjecting the pulp/fibers to mechanical shear forces.

In another aspect, the cellulose fiber may be a microfibrillated cellulose (MFC).

The particle size of the cellulose fiber for use in the present disclosure may be, for example, about 10 μm to about 120 μm. In some aspects, the average particles size of the cellulose fiber may be about 21 μm to about 120 μm, or about 50 μm to about 100 μmm or about 70 to about 90 μm.

The cellulose fiber used to make the sugar composite particles are insoluble. This means that the cellulose fibers may be 100% insoluble in water and in common organic solvents, but form a dispersed colloidal suspension with minimum agitation. The insolubility of cellulose fiber allows the cellulose fiber to function as an agent for nucleation and growth of sugar crystals, as explained in more detail below. In some aspects, a solubility of the cellulose fiber in water at 25° C. may be, for example, at least less than about 10 mg/L.

The cellulose fiber used to make the sugar composite particles is preferably water insoluble (for example, inulin is a water soluble fiber, while lignin and hemicellulose are water insoluble fibers). While water insoluble cellulose fiber is well-known in the art, it is noted that the '299 application, for example, provides example processes for treating spend coffee grounds to obtain a water soluble fraction and a water insoluble fraction.

The cellulose fiber used to make the sugar composite particles may be decolored or be substantially colorless. When the cellulose fiber is decolored or colorless, the sugar composite particles may have a similar color as table sugar. As used in the present application, “decolored” refers to a source of cellulose fiber having a color other than, for example, white or colorless, such as the brown color of spend coffee grounds, that has had that color removed by a treatment process.

The cellulose fiber used to make the sugar composite particles may be chosen such that it substantially adds no taste to the sugar composite particles.

### Crystalline Sugar Particles

The crystalline sugar particles of the crystalline sugar composite powder may consist essentially of the sugar. In some aspects, the crystalline sugar particles may consist of the sugar. This means that, when the sugar is sucrose, the crystalline sugar particles may be substantially or entirely sucrose.

The crystalline sugar particles include crystalline sugar particles obtained by the solvent inversion process of the present disclosure, which is discussed in more detail below. That is, the crystalline sugar particles are crystals of the sugar that recrystallized from the supersaturated solution of the sugar and the cellulose fiber, wherein the crystalline sugar particles are particles of sugar that did not form on the cellulose fiber. This differentiates the crystalline sugar particles from the separate and distinct sugar composite particles, which are the particles where the sugar forms a plurality of overlapping co-crystals on the cellulose fiber.

The crystalline sugar particles may have a first average particle size of about 5 μm to about 100 μm. In some aspects, the first average particles size may be about 15 μm to about 75 μm; or about 30 μm to about 60 μm.

In some aspects, the first average particle size of the crystalline sugar particles may be smaller than the average particle size of common table sugar.

In some aspects, the first average particle size of the crystalline sugar particles is larger than the average particle size of the sugar crystals of the sugar composite particles.

### Sugar Composite Particles

The sugar composite particles may consist essentially of the cellulose fiber and a plurality of sugar crystals formed on a surface of the cellulose fiber. In some aspects, the sugar composite particles may consist of the cellulose fiber and the sugar crystals. This means that, for example, when the sugar is sucrose, the sugar composite particles may be substantially or entirely made up of only the cellulose fiber and the sucrose crystals.

The sugar crystals may be formed on the surface of the cellulose fiber by the solvent inversion process of the present disclosure, which is discussed in more detail below. More specifically, without being bound by any theory, the surface and/or pores of the cellulose fiber, particularly water insoluble cellulose fiber, acts a nucleating agent such that the sugar in the supersaturated suspension preferentially crystallizes on the surface of the cellulose fiber.

As used herein, “formed on a surface of the cellulose fiber” means that crystallized sugar is directly disposed on and occupies both interior and exterior regions of the cellulose fiber. By interior region, this refers to crystals that have precipitated within pores in the wall of the fiber. In other words, the crystalline sugar is embedded in the cellulose fiber.

The average particle size of the sugar composite particles may be larger than the average particle size of the crystalline sugar particles, and may also be larger than the average particle size of table sugar. In some aspects, the average particle size of the sugar composite particles may be about 50 to about 500 μm. In some aspects, the second average particle size may be about 100 μm to about 400 μm, or may be about 200 μm to about 300 μm.

The average particle size of the sugar crystals formed on the cellulose fiber of the sugar composite particles may be smaller than the average particle size of the crystalline sugar particles.

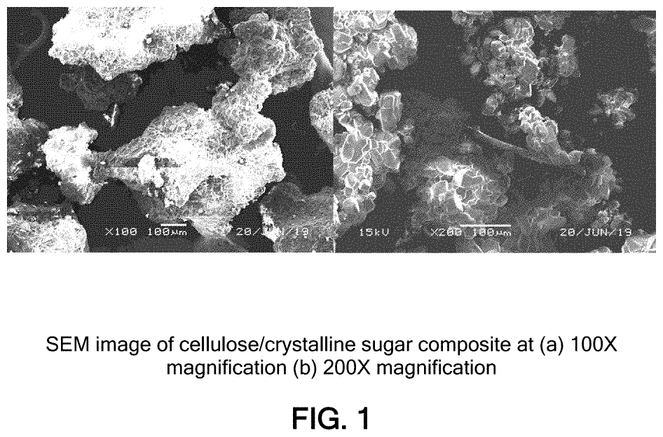

In some aspects, the sugar composite particles may have a structural shape that looks similar to a raspberry or to rock candy by virtue of the sugar crystals being disposed on the cellulose fiber in the form of a plurality of overlapping co-crystals on the surface of the cellulose fiber. This is shown, for example, in the scanning electron microscope (SEM) image of FIG. 1.

### Process for Forming a Crystalline Sugar Composite Powder

Another aspect of the present disclosure is a process for forming a crystalline sugar composite powder of the present disclosure. The process involves solvent inversion to precipitate a plurality of sugar co-crystals on cellulose fiber, while also forming the separate and distinct crystalline sugar particles (which are not formed on a cellulose fiber).

The process is disclosed below with reference to “steps.” However, the term “step” is used as a convenience for purposes of illustration. For example, a person of ordinary skill in the art would understand that the process need not be rigidly followed in this manner; that the listed steps may be subdivided into two or more separate steps; and/or that the various steps or elements of the steps may be performed in a different order, so long at the various active steps are designed to achieve the same purpose.

In brief summary, the process includes, for example: Step A of forming a supersaturated sugar-cellulose suspension; Step B of reducing the solubility of the suspension to precipitate the sugar composite particles (having the sugar embedded in the fiber) and the crystalline sugar composite; and Step C of separating and/or drying the solids to obtain the crystalline sugar composite powder.

### Step A

In the Step A, the process may include suspending cellulose fiber in a supersaturated aqueous solution of a sugar to form a sugar-cellulose suspension. The resulting suspension may have a temperature of from about 5 to about 60° C. Here, the sugar may be one or more of the example sugars described above, such as, for example, sucrose. Likewise, the cellulose fiber used in this step may be one or more of the example cellulose fibers described above, such as, in particular, a decolored, water-insoluble cellulose fiber.

The Step A may include first forming a supersaturated solution of the sugar, and then adding the cellulose fiber to the supersaturated solution to form a sugar-cellulose suspension (also referred to simply as “the suspension” or “the resulting suspension”).

The Step A may also include predetermining an amount and/or a type of cellulose fiber to add to the supersaturated solution to form the suspension.

In some aspects, an amount of the cellulose fibers added to the sugar-cellulose suspension is about 0.1 to about 20% by weight, when a total weight of the sugar-cellulose suspension is considered to be 100% by weight. In some aspects, this amount may be about 0.1 to 10% by weight, or about 0.1 to 5% by weight.

### Step B

In the Step B, the process may include adding to the sugar-cellulose suspension to a solvent having at a temperature of from about −20 to about 25° C., and then allowing a temperature of the resulting mixture to rise to a room temperature of about 20° C. to about 25° C., thereby reducing the solubility of the sugar within the resulting suspension (i.e., solvent inversion). In the Step B, the sugar precipitates out of the suspension to form a mixture of solids that includes the crystalline sugar particles and the sugar composite particulars.

Without being bound by any theory, the sugar preferentially precipitates on the surface of the cellulose fibers, thereby forming relatively large sugar composite particles, while the sugar also precipitates to form the relatively small crystalline sugar particles (that is, as explained above, the crystalline sugar particles are not formed on cellulose fiber, and are separate and distinct particles from the sugar composite particles). In other words, the cellulose fiber functions as a nucleating agent, while crystalline sugar particles also precipitate directly from the suspension without being formed on cellulose fiber.

In some aspects, allowing the temperature of the resulting mixture to rise to about room or ambient temperature is performed by heating the resultant at a rate of about 1° C. to about 5° C. per minute. The method of heating the resulting mixture is not particularly limited. Alternatively, allowing the temperature of the resulting mixture to rise may not include heating (in other words, the temperature of the resulting mixture would rise by being exposed to the ambient room temperature).

The solvent used in the Step B may include an alcohol. In one aspect, the solvent may be methanol. In another aspect, a co-solvent system of alcohol and another solvent is contemplated, such as, for example, methanol and water.

The amount of solvent added in the Step B is not particularly critical. However, a ratio of the total amount of solvent added to the amount of the resulting suspension may be, for example, about 50:50 by volume to about 90:10 by volume (alcohol:water), or about 50:50 by volume to about 80:20 by volume (alcohol:water).

The Step B may be performed under continuous or intermittent stirring or mixing using, for example, a known stirring device, mixing device, or the like.

### Step (C)

In the Step C, the mixture containing the solids (the crystalline sugar particles and the sugar composite particles) may be dried to obtain either a crystalline sugar composite powder.

The Step C may include, for example, a separation step of removing liquid from the mixture, such as, for example, by decanting, evaporation, vacuum concentration, lyophilization, filtration, and the like.

The Step C may include heating the mixture containing the solids to a temperature of about 50 to about 80° C. Neither the time period nor the method of heating are particularly limited, so long as the purpose of reducing the water and solvent content of the solids is achieved. As noted above, a solids content of the crystalline sugar composite powder may be, for example, about 96 to about 99.9 percent by weight, preferably about 97.5 to about 99.9 percent by weight (meaning that the moisture content may be less than 4 percent by weight, preferably less than 2.5 percent by weight).

In one aspect, the Step C may include removing liquid from the mixture followed by performing the heating on the solids.

### Step D

The process may include a Step D of reducing a particles size of the crystalline sugar composite powder obtained in the Step C. The Step D may be performed, for example, by grinding, crushing, and/or cutting using, for example, any known device for this purpose.

### Step E

The process may include a Step E of packaging the crystalline sugar composite powder obtained in the Step C and/or in the Step D in relatively small quantities (such as in the well-known form of packets of table sugar (e.g., 4 gram packets)) or relatively large quantities (such as in bulk, including boxes, bags, etc. commonly used in the art for selling and/or transporting bulk amounts of natural and artificial sweeteners) for transportation and/or for commercial, industrial, or individual use.

### Applications

The crystalline sugar composite powder may be used, for example, as a sugar substitute ingredient having a morphology that is interpreted upon consumption as having, for example, a higher level of sweetness and/or a lingering sweetness, thereby allowing a lower level of sugar.

Without being bound by any theory, these benefits are provided, for example, by structural features of the crystalline sugar composite powder. For example, as explained above, the crystalline sugar particles may have a relative small particle size (smaller, for example, than the average particle of size of table sugar), which may provide a high initial sweetness. On the other hand, the sugar composite particles have a plurality of overlapping co-crystals of sugar, which are believed to dissolve relatively slower and thus provide a lingering sweetness. Further, the bond between the co-crystals of sugar and the cellulose fiber may also result in a slower dissolution, thereby also providing a lingering sweetness. In this regard, sugar crystals forming within a pore of the cellulose (as cellulose fiber may be highly porous), may also provide a slower dissolution and lingering sweetness.

As a sugar substitute, the crystalline sugar composite powder can be used entirely in place of, or partially in place of, table sugar or another sweetener. For example, the crystalline sugar composite powder may be used in dry were table sugar is commonly used, as would be well understood by persons of ordinary skill in the art.

A food product can be made using the crystalline sugar composite powder as an ingredient. In some aspects, the food product contains minimal or substantially no water, and such food products are known in the art.

Example food products are not limited, and include, for example, a bread, a cake, a candy, a chocolate confection, a cookie, a custard, a frosting, an icing, a frozen desert, a pie, a tart, a pastry, a pudding, a quick-bread, a granola bar, a cream, a butter, an oil-based sauce, or the like, made using the crystalline sugar composite powder of the present disclosure as a sweetener (or full or partial substitute for granulated sugar, powder sugar, etc.) and/or contains therein or thereon the crystalline sugar composite powder of the present disclosure.

The crystalline sugar composite powder may also be used as an additive in a drink, such as, for example, a sweetener for coffee, tea, etc.

The crystalline sugar composite powder may be used as a confection topping, such as, for example, in a low moisture application like a topping for a donut, cookie, cake, etc.

The particle size of the crystalline sugar composite powder may be reduced/pulverized/etc. to have a size similar to powdered sugar/confectioner's sugar.

The crystalline sugar composite powder may be used as a sweetener in a fat based application, such as chocolates and fat-based sauces.

When used as a sugar substitute, the crystalline sugar composite powder can provide the benefit of sugar reduction. Stated differently, when the sugar used to form the crystalline sugar composite powder is sucrose, less crystalline sugar composite powder can be used to obtain the same level of sweetness as compared to using table sugar. In some aspects, the reduction in sugar can by using the crystalline sugar composite powder may be 25% or more by weight, 30% or more by weight, 35% or more by weight, or 40% by more or weight, or higher reductions. This means that, for an application calling for X weight of table sugar, a 25% weight reduction would result in 0.25× of the crystalline sugar composite and 0.75× of table sugar.

### EXAMPLES

In the following, although embodiments of the present disclosure are described in further detail by means of Examples, the present disclosure is not limited thereto.

### Example 1—Production of Crystalline Sugar Composite Powder with Insoluble Cellulose from Coffee Grounds (“Raspberry Crystalline Sugar, 1% MFB026”)

In Example 1, a crystalline sugar composite powder was formed by the solvent inversion process, using sucrose as the sugar, methanol as the solvent, and decolored, water-insoluble cellulose fiber obtained from spend coffee grounds according to the method of the '299 application (hereinafter referred to as “MFB026”) as the cellulose fiber. The crystalline sugar composite powder obtained in Example 1 is also referred to herein and the Drawings as simply Raspberry Crystalline Sugar, or as Raspberry Crystalline Sugar, 1% MFB026.

A supersaturated aqueous solution of granulated sugar (i.e., sucrose or table sugar) was prepared, and about 1 wt % of the cellulose fibers was added to form a sugar-cellulose suspension. The suspension was then poured into double jacketed container of methanol, which was being held at a temperature of about 5° C. using a chiller obtained from Thermo Fischer Scientific, while stirring the methanol at about 500 rpm using a magnetic stirrer. After the suspension was fully added to the methanol container, the temperature control of the methanol container was switched off, and the temperature of the resulting mixture was allowed to slowly rise to room temperature under stirring. The transparent mixture turned white approximately 30 minutes after adding the suspension, which indicated that sugar crystals had precipitated to form both the composite particles and the crystalline sugar particles. The reaction was continued for another hour, and the magnetic stirrer was switched off. The sugar composite particles and the crystalline sugar particles (i.e., the solids) settled at the bottom of the double jacketed container, and the supernatant was discarded (i.e., the liquid fraction was separated from the solids). The solids were then transferred to a plate and left to dry overnight at a temperature of about 60° C. The following day, the solids were inspected for complete drying. Once it was determined that the solids had fully solidified or dried, the solids were transferred to a blender to reduce the particle size of the solids.

The solids having the reduced particle size were imaged using Scanning Electron Microscopy (SEM), and the formation of composite particles having a plurality of relatively small, overlapping sugar co-crystals embedded on and within the cellulose fiber was observed, along with free crystalline sugar particles. The formation of the composite particles was considered surprising, as there was no known techniques for forming this type of structural relationship.

Since it was found to be possible to crystallize very small, overlapping sugar co-crystals on and within the cellulose fibers, the inventors hypothesized that the composite particles might dissolve slower than regular granulated sugar to provide lingering sweetness compared to table sugar. In order to test this hypothesis, two sensory experiments were designed.

For the first test, the sweetness of the crystalline sugar composite powder was compared to regular sugar. A trained panel tasted both the composite powder and the regular sugar, in a blind test, and the composite powder was described to have a sweetness very close to the sweetness of raw sugar. The trained panel used for the first test was a highly trained descriptive analysis panel using the Spectrum Method (Sensory Evaluation Techniques, Meilgaard, Civille, and Carr). This method uses a universal fifteen point scale. (1=threshold strength of attribute, 7.5=slight-moderate, and 15=strong.).

For the second test, a control chocolate prepared using regular sugar was compared to chocolate prepared with the crystalline sugar composite powder and having a 40% reduction in sugar [meaning that 40% less sugar was used in the formulation, which means that for each 100g of regular sugar, 60g of crystalline sugar composite was used, and the remainder was a bulking agent, such as inulin; in other words, if the control chocolate was made with 100 g of regular sugar, then the reduced sugar chocolate was made with 60 g of the crystalline sugar composite and bulking agent]. A trained panelist perceived the same sweetness as the control chocolate.

Based on the encouraging initial results, further testing was performed with regard to, for example, sensory results and physical properties provided by the unique structure of the crystalline sugar composite powder.

### Example 2—Sweetness

A study was designed to understand if crystalline sugar composite powder obtained in the same manner as Example 1 in a 30% or 40% reduced sugar chocolate (in the same manner explained above) is as sweet or sweeter than a full sugar chocolate. For this study, panelists were asked to compare the sweetness of four chocolate samples (n=25) at three intervals, and thee powders (n=13, directional data only) at three-time intervals.

### Samples Tested

TABLE 1

| Chocolates | Sugar Powders |
|---|---|
| All chocolate samples were prepared with | Panelists were served exactly 1 g of product |
| combinations of SW.157 (common, | for each sample and were instructed to place |
| granulated sugar), crystalline sugar composite | the entire 1 g sample into their mouths and let |
| powder (also referred to herein as Raspberry | it dissolve for 30 seconds. Their perceptions |
| Crystalline or MFB026), and inulin (for | overtime were recorded. |
| bulking) | |
| Sample 1A: Reference, full sugar chocolate | Sample 2A: 1 g: Reference, SW.157 |
| | (granulated sugar) |
| Sample 1B: 30% Reduced sugar (crystalline | Sample 2B: 1 g: 60:40 Mixture by weight |
| sugar composite powder:bulking agent 7:3) | (SW.157:crystalline sugar composite powder) |
| Sample 1C: 40% Reduced sugar (crystalline | Sample 2C: 1 g: 100% crystalline sugar |
| sugar composite powder:bulking agent 6:4) | composite powder |
| Sample 1D: 40% Reduced sugar (granulated | |
| sugar:bulking agent 6:4 ) | |

SW.157 is common, common, table grind sugar, otherwise known as “granulated sugar,” such as made by American Crystal Sugar Co.

### Summary of the Results

The Sample 1B chocolate (30% Reduced composite powder) was found to be acceptable, with the Sample 1C chocolate (40% Reduced composite powder) showing a lower sweetness but becoming sweeter through the chewing and linger. However, in the powder application, the Sample 2B (60:40 Mixture granulated:composite) was found to be slightly inferior in the powder application as compared to the Sample 2B (100% granulated sugar) and the Sample 2C (100% composite powder). A general comment from some panelists was that samples having the composite powder may not have been as sweet initially but the sweetness increased over time.

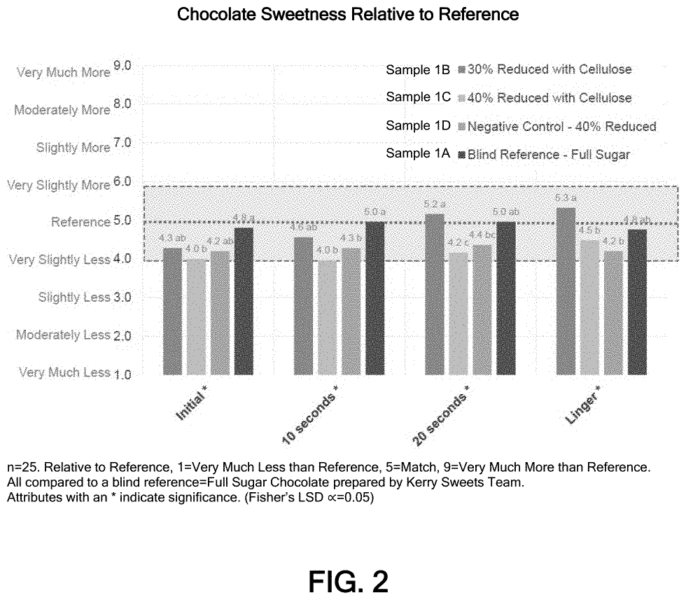

### Detailed Results—FIG. 2—Chocolate Sweetness Relative to Reference

A chart showing chocolate sweetness related to Reference is shown in FIG. 2. A reference should be considered as the base line for expectations. In theory every “blind reference” should match the 5.0 exactly. Because sensory science relies on human beings, which are unpredictable, that 5.0 base expectation may vary slightly above or below 5.0. All relative to reference results should be compared to the “blind reference” sample as that is what panelists are sensing.

Initially, the only product that was significantly lower than the blind reference in sweetness was the Sample 1C (40% Reduced composite powder).

The Sample 1C (40% Reduced composite powder) continued to be significantly lower in sweetness than the blind reference at 10 and 20 seconds.

At 10 seconds, the Sample 1D (40% Reduced granulated) was also significantly lower than the blind reference, but is no longer showing significance from the blind reference at 20 seconds.

No significance was found in the sweetness linger compared to the Sample 1A (blind reference; granulated sugar). The Sample 1B (30% Reduced composite powder) was trending to be higher than the Sample 1A (blind reference). Further, the Sample 1D (40% Reduced granulated) was trending to be lower than the blind reference.

Primarily, the Sample 1B (30% Reduced composite powder) trended about the same as the Sample 1C (40% Reduced composite powder) until the 20 second interval, where it became significantly higher. That trend continued into the sweetness linger.

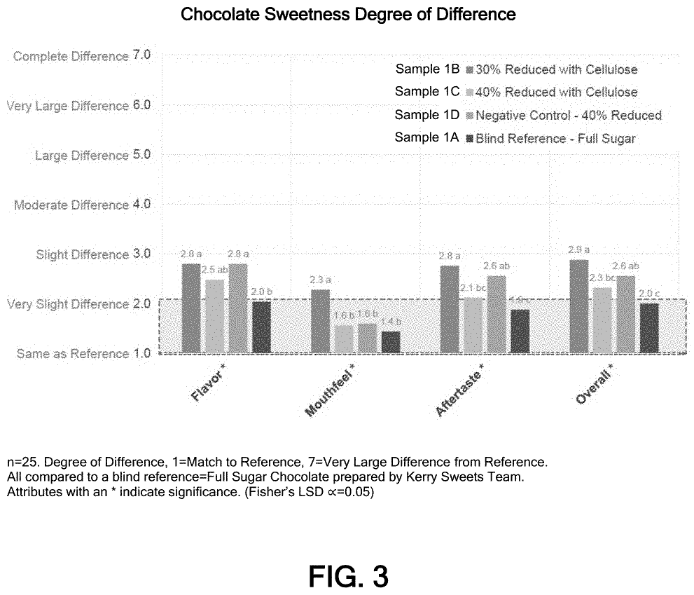

### Detailed Results—FIG. 3—Chocolate Sweetness Degree of Difference

A chart showing chocolate sweetness degree of difference is shown in FIG. 3, and having scores for flavor, mouthfeel, aftertaste, and overall score.

The Sample 1B (30% Reduced composite powder) and the Sample 1D (40% Reduced granulated) were found to be very slightly different than the Sample 1A (blind reference) in flavor, aftertaste, and overall. The Sample 1B (30% Reduced composite powder) was also found to be very slightly different in mouthfeel.

Here, the degree of difference takes into account the flavor as a whole, whereas the relative to reference asks specifically about sweetness at different time intervals. This was hypothesized as explaining why significance was seen in the Sample 1C (30% Reduced composite powder) at most sweetness time intervals, but not seen as statistically significant from the Sample 1A (blind reference) in the degree of difference.

### Detailed Results—Panelist Comments on Chocolates

TABLE 2

| | | | Sample 1D |
|---|---|---|---|
| Sample 1A | Sample 1B | Sample 1C | Negative Control: |
| Blind Control: | 30% Reduced composite | 40% Reduced composite | 40% reduced |
| Full Sugar Chocolate | powder* | powder* | granulated sugar* |
| Musty, earthy upfront | Waxier texture | Slightly more cocoa | Less sweet |
| Alternative sweetener | More cocoa flavor | flavor | Sweetness builds in |
| flavor | Less sweet | Less sweet overall | the later time intervals |
| | Lower initial and | Less initial | More bitter |
| | middle sweetness | sweetness, but gradually | More upfront bitter |
| | More fudge flavor | became sweeter | More cocoa in finish |
| | More cocoa flavor | Sweeter in finish | Gritty/Grainy texture, |
| | Dark chocolate flavor | More bitter | powdery bite, tooth etch |
| | More milky, creamy | No bitter peak like | More chalky |
| | flavor | reference | Musty/Earthy aftertaste |
| | Milky flavor in | Lacks aroma | Burnt flavor |
| | aftertaste | More dense | More sour |
| | More astringent | Richer/dark chocolate | |
| | More nutty flavor | flavor | |
| | More lipolytic and waxy | More mouthcoating | |
| | in the finish | Less mouth drying | |
| | Brown sweet finish | | |

*compared to the Reference sample (Full Sugar Chocolate)

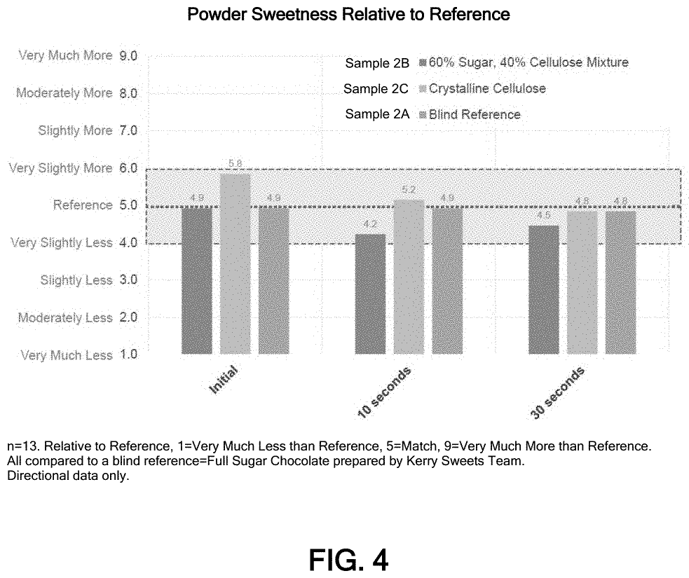

### Detailed Results—FIG. 4—Powder Sweetness Relative to Reference

A chart showing chocolate sweetness related to Reference is shown in FIG. 4.

The Sample 2C (powder composite) trended higher than the Sample 2A (blind reference, 100% granulated sugar) initially, but close to the Sample 2A at the 10 and 20 second intervals.

The Sample 2B (blend) trended lower in sweetness than the Sample 2C (composite powder) initially and at the 10 second interval.

At 30 seconds, all three samples were trending very close together.

There was large variations in panelist responses for all three products.

Directional data only was collected for the samples due to the number of participants.

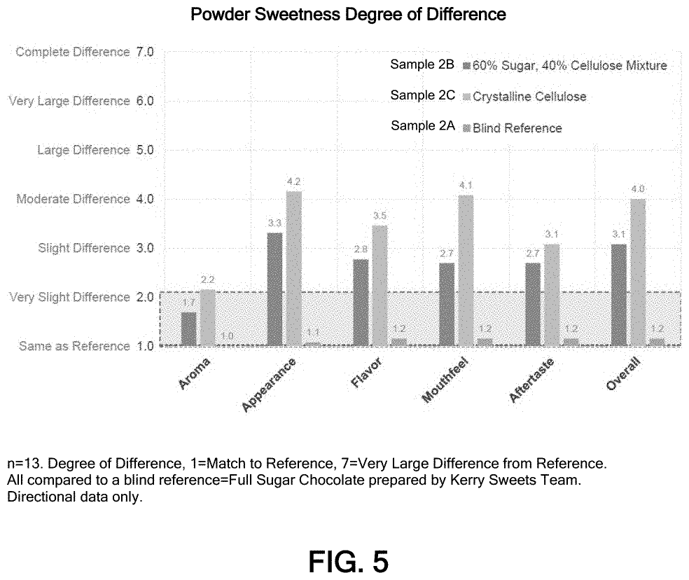

### Detailed Results—FIG. 5—Powder Sweetness Degree of Difference

The Sample 2C (composite powder) and the Sample 2B (blend) trended to be slight to moderately different for all modalities, except in aroma. In this regard, the Sample 2B (blend) tended slightly lower in difference than the Sample 2C (composite powder).

There was large variations in panelist responses for all three products.

Directional data only was collected for the samples due to the number of participants.

### Detailed Results—Panelist Comments on Powders

TABLE 3

| | Sample 2B | |
|---|---|---|
| Sample 2A | 60/40 blend | |
| Blind Control | (Granulated Sugar/Composite | Sample 2C |
| (100% Granulated Sugar) | Powder) | 100% Composite Power |
| No perceived differences among | Starchy, stale flavor | Clumpy appearance and less |
| panelists | Flavor is less “clean” than pure | granular |
| | sugar | Slight vanilla flavor |
| | More powdery, less granular in | Powdery texture and appearance |
| | appearance | Very strong aftertaste |
| | Musty aroma | Musty, plastic off-note |
| | Powdery mouthfeel | Sweetness lingers more |
| | Musty, fruity flavor | Musty aroma |
| | A large amount of variance in | More opaque white |
| | panelist feedback regarding | More brown sugar, caramelized |
| | sweetness | flavor |
| | Primarily panelists are saying | Sample feels thicker in mouth |
| | that initially the product is not as | Starchy, stale flavor |
| | sweet as the reference | Moderate astringency |

### Example 3—Production of Crystalline Sugar Composite Powder with Rice Bran Fiber (“Raspberry Crystalline Sugar, 1% RiFiber”)

In Example 3, a crystalline sugar composite powder was formed by the same solvent inversion process as in Example 1, except that rice bran was used as the insoluble cellulose fiber (hereinafter referred to as “RiFiber”), but in the same 1% by weight as in Example 1. The crystalline sugar composite powder obtained in Example 3 is also referred to herein and the Drawings as Raspberry Crystalline Sugar, 1% RiFiber.

### Reaction Kinetics Comparison

With regard to the reaction kinetics, comparing the crystalline sugar composite powder of Example 1 (Raspberry Crystalline Sugar, 1% MFB026) with the crystalline sugar composite powder of Example 3 (Raspberry Crystalline Sugar, 1% RiFiber) was not entirely easy for two reasons.

The first reason was that the mixtures of the fibers with the supersaturated sugar are both mildly opaque due to the RiFiber and MFB026 boing being insoluble fibers. Thus, the formation of the composite particles cannot be easily observed, as compared to when sugar is recrystallized from methanol with no nucleate or a soluble nucleate like inulin (that is, if the mixture is cloudy, then one cannot easily observe the initial formation of the composite particles and crystals, whereas, if the mixture is clear, then one can more easily observe the formation of the crystals).

The second reason was that the Raspberry Crystalline Sugar, 1% RiFiber of Example 3 was immediately decanted at the 3 hour mark, whereas the Raspberry Crystalline Sugar, 1% MFB026 of Example 1 was allowed about 15 to 30 minutes of settling time. This was to optimize drying conditions.

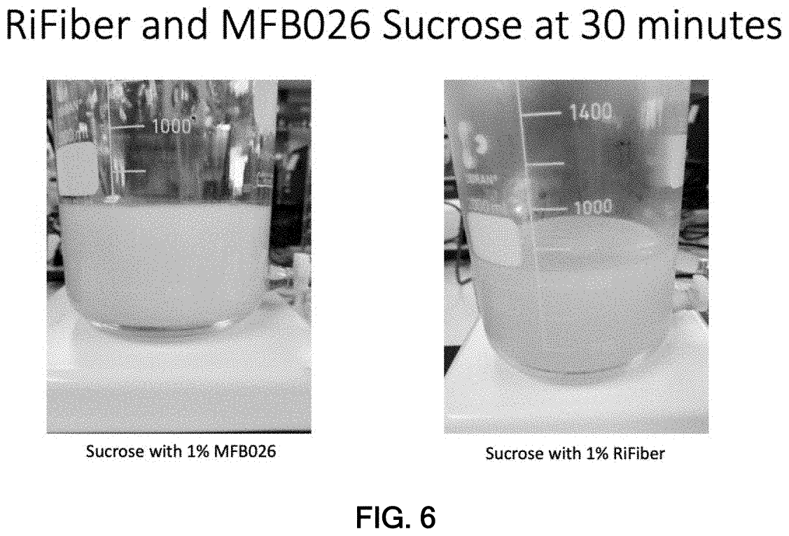

FIG. 6 shows images of the composite powder mixture of Example 1 (Raspberry Crystalline Sugar, 1% MFB026) and Example 3 (Raspberry Crystalline Sugar, 1% RiFiber) at 30 minutes after the addition of supersaturated sugar solution (with fibers) is added to methanol

### Comparative Example 1—Production of Crystallized Sugar Powder by Solvent Inversion (“Recrystallized Sugar”)

In Comparative Example 1, a crystalline sugar was formed by the same solvent inversion process as in Example 1, except no cellulose fiber was added. The crystalline sugar powder obtained in Comparative Example 1 is also referred to herein and the Drawings as simply Recrystallized Sugar, or Recrystallized Sugar, No Fiber.

### Comparative Example 2—Production of Crystallized Sugar Powder by the Method of Saska Article (“Saska Sugar”)

In Comparative Example 2, a crystalline sugar was formed by the solvent inversion process disclosed in Michael Saska, Precipitation, melting and solubility of sucrose re-crystallized from methanol, available at https://www.researchgate.net/publication/289604466_Precipitation_melting_and_solubility_of_sucrose_re-crystallized_from_methanol. The crystalline sugar powder obtained in Comparative Example 2 is referred to herein and in the Drawings as “Saska Sugar.”

The largest difference in methodology between the solvent inversion process of the present application used in Example 1 and the method of Saska (other than the use of insoluble cellulose fiber) was the absence of a 250 mL jacketed beaker—a water bath with a thermometer was utilized instead. Further, filtration (specified by the method of Saska) was also not necessary, as the methanol and water had both almost entirely evaporated before the four hour mark.

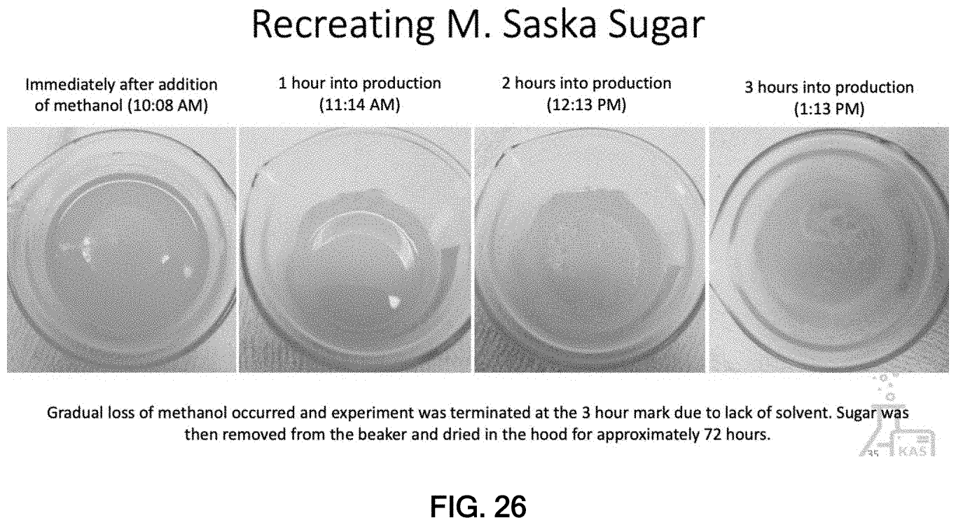

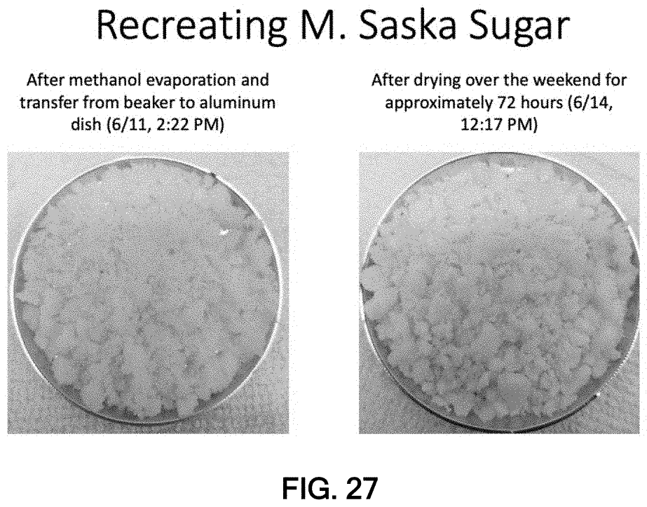

FIGS. 26 and 27 show images from the process.

### Example 4—Dissolution Testing

In the following aspects of Example 4, five types of sugar were compared for:
(1) SW.157—common, granulated sugar
(2) Raspberry Crystalline Sugar, 1% MFB026 of Example 1
(3) Raspberry Crystalline Sugar, 1% RiFiber of Example 3
(4) Recrystallized Sugar of Comparative Example 1
(5) Saska Sugar of Comparative Example 2.

### Example 4A

In Example 4A, SW.157 (common, granulated sugar) and Raspberry Crystalline Sugar, 1% MFB026 were used to examine dissolution rate.

For Example 4A, the samples tested were 100% SW.157 as compared to a 40% Reduced composite powder (Raspberry Crystalline Sugar, 1% MFB026+bulking agent 6:4)

Both samples were passed through a 60 mesh sieve to achieve uniform particle size. The samples (2.5 g) were pre-weighed in weigh boats. Water (25 mL) was pre-measured into 30 mL beakers, and the samples were added to form 10% by weight “sucrose” solutions. The timer was started when the sample was added, and the stir plate was turned on. A ⅛×½ inch stir bar was used to agitate the samples. Every 15 seconds, a 1 mL aliquot was pipetted from the top of the beaker and analyzed by the refractometer. This aliquot was returned to the 30 mL beaker after being read. At each 15 second interval, temperature was also recorded. The stir plate's heat setting was kept on to keep the sample warm.

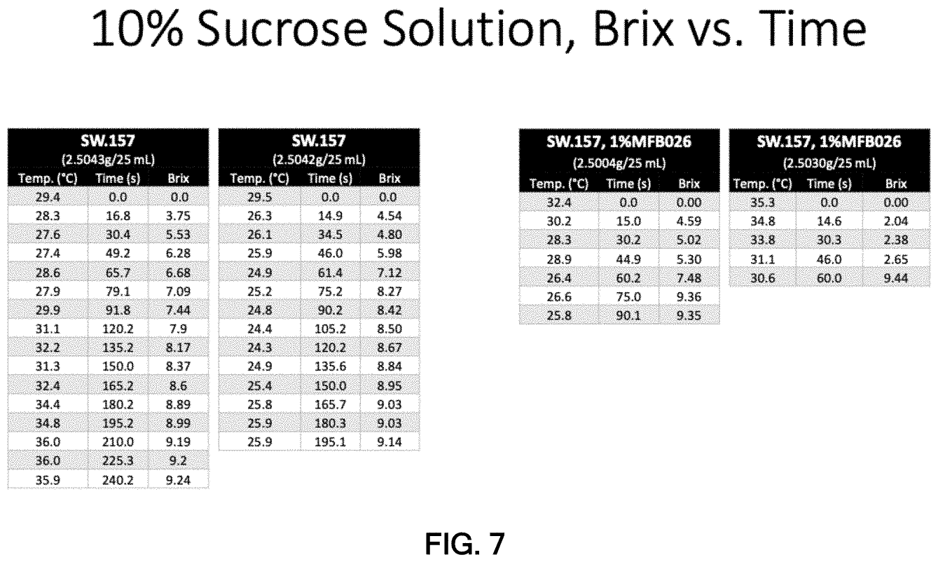

The results are shown in FIG. 7. As shown, the blend of 40% Reduced Raspberry Crystalline Sugar, 1% MFB026 dissolved completely within 60 to 90 seconds, while the SW.157 alone took between 200 to 240 seconds.

### Example 4B

In Example 4B, the SW.157 (granulated sugar), the 40% Reduced Raspberry Crystalline Sugar, 1% MFB026, and the Recrystallized Sugar (no cellulose fiber) were compared.

All of the samples were passed through a 60 mesh sieve to achieve uniform particle size. The samples (0.5 g) were pre-weighed in weigh boats. Water (25 mL) was pre-measured into 30 mL beakers, and the samples were added to form 2% by weight “sucrose” solutions. The timer was started when the sample was added, and the stir plate was turned on. A ⅛×½ inch stir bar was used to agitate the samples. At 10 seconds or 60 seconds, a 1 mL sample was pipetted from the top of the beaker, filtered through a 0.2 micron syringe filter, and stored in a 1.5 mL HPLC vial. Samples were analyzed by HPLC and quantified using a sucrose calibration curve. Temperature was recorded before sugar samples were added.

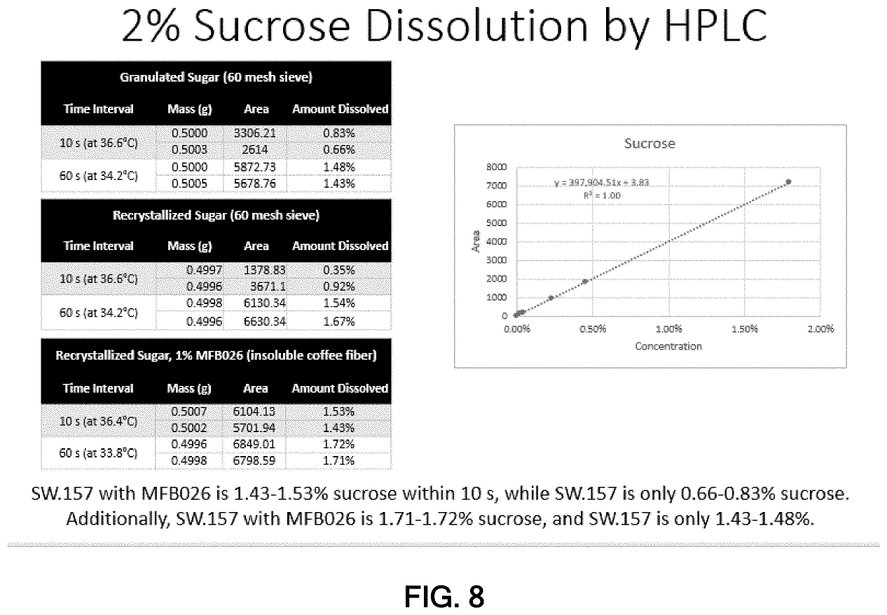

The results are shown in FIG. 8.

### Example 4C

In Example 4C, only the SW.157 (granulated sugar) was tested.

The samples were passed through a 60 mesh sieve to achieve uniform particle size. The samples (4 g) were pre-weighed in weigh boats. Water (100 mL) was pre-measured into 250 mL beakers. Beakers were heated in the microwave to achieve an approximate temperature of 36° C. The stir plate was turned on before the timer began. The timer was started when the sugar sample was added to the beaker. A ⅛×½ inch stir bar was used to agitate the samples. At 5 seconds, a 1 mL sample was pipetted from the top of the beaker and measured by the refractometer. Temperature was recorded before the sugar sample was added.

The results were not satisfactory.

### Example 4D

In Example 4D, the Raspberry Crystalline Sugar, 1% MFB026 was compared to the Recrystallized Sugar (no cellulose fiber).

The sugar samples were passed through a 60 mesh sieve to achieve uniform particle size. Samples (2 g) were pre-weighed in weigh boats. Water (20 mL) was pre- measured into 30 mL beakers. Beakers were heated in the microwave to achieve an approximate temperature of 36° C. The stir plate was turned on before the timer began. The timer was started when the sugar sample was added to the beaker. A ⅛×½ inch stir bar was used to agitate the samples. At 10, 30, or 60 seconds, a 1 mL sample was pipetted from the middle of the beaker and measured by the refractometer. Temperature was recorded before the sugar sample was added.

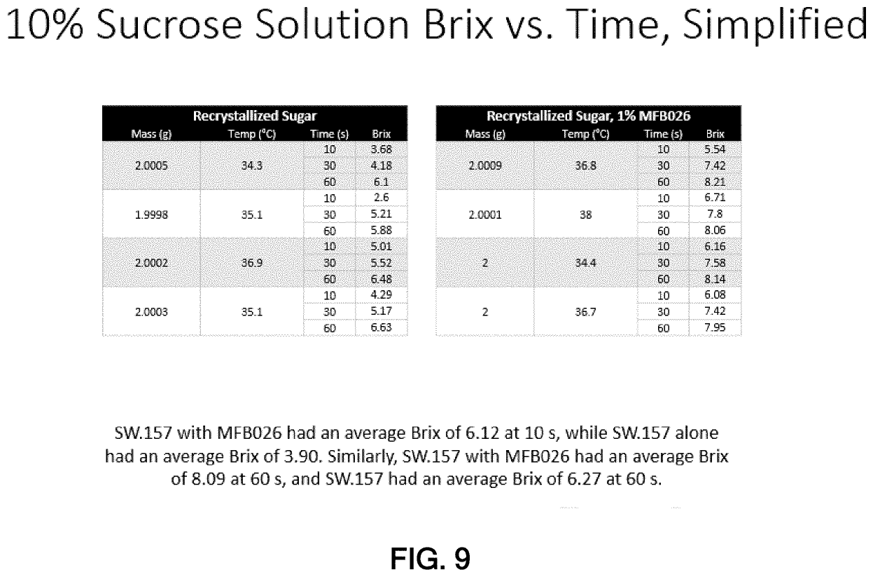

The results are shown in FIG. 9.

### Example 4E

In Example 4E, the Raspberry Crystalline Sugar, 1% MFB026 was compared to the Recrystallized Sugar (no cellulose fiber).

All sugar samples were passed through a 60 mesh sieve to achieve uniform particle size. Samples (0.4 g) were pre-weighed in weigh boats. Water (40 mL) was pre-measured into 50 mL beakers and allowed to come to 36° C. in a water bath for one hour. Two different approaches were taken with this method:
(1) No stir bar was utilized for this experiment in the attempt to remove potential variability from stir speed; or
(2) A ⅛×½ inch stir bar was used. The stir plate was turned on before the timer began. The timer was started when the sugar sample was added to the beaker.
   At a given time interval, a 1 mL sample was pipetted from the middle of the beaker, filtered through a 0.2 micron syringe filter, and stored in a 1.5 mL HPLC vial. Samples were analyzed by HPLC and quantified using a sucrose calibration curve.

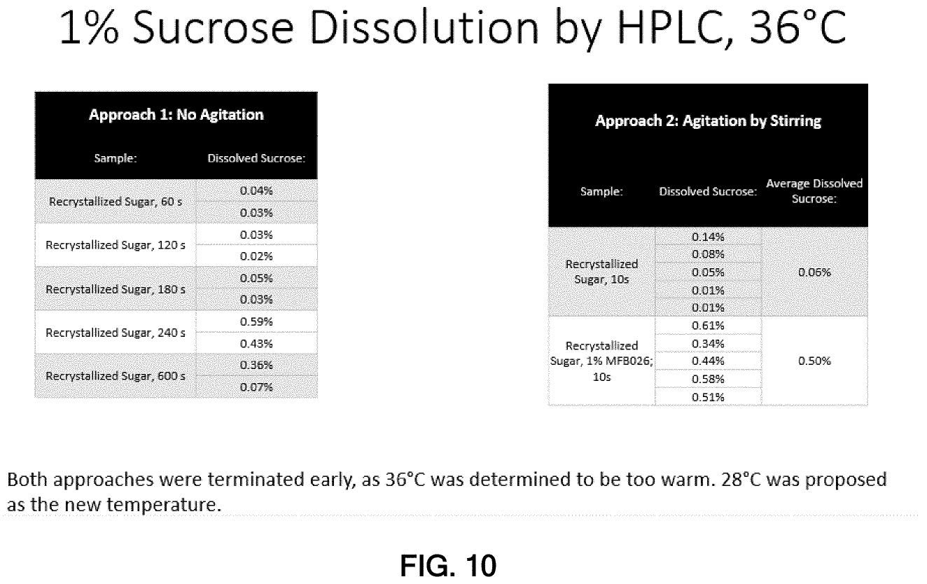

The results are shown in FIG. 10.

### Example 4F

In Example 4F, each of the Raspberry Crystalline Sugar, 1% MFB026, the Raspberry Crystalline Sugar, 1% RiFiber, the SW.157 (granulated sugar), the Recrystallized Sugar (no cellulose fiber), and the Saska Sugar were all compared.

The sugar samples were passed through a 60 mesh sieve to achieve uniform particle size. Samples (0.4 g) were pre-weighed in weigh boats. Water (40 mL) was pre-measured into 50 mL beakers and allowed to come to 28° C. in a water bath for 1 hour. The stir plate was turned on before the timer began. The timer was started when the sugar sample was added to the beaker. A ⅛×½ inch stir bar was used to agitate the samples. At a given time interval, a 1 mL sample was pipetted from the middle of the beaker, filtered through a 0.2 micron syringe filter, and stored in a 1.5 mL HPLC vial. Samples were analyzed by HPLC and quantified using a sucrose calibration curve.

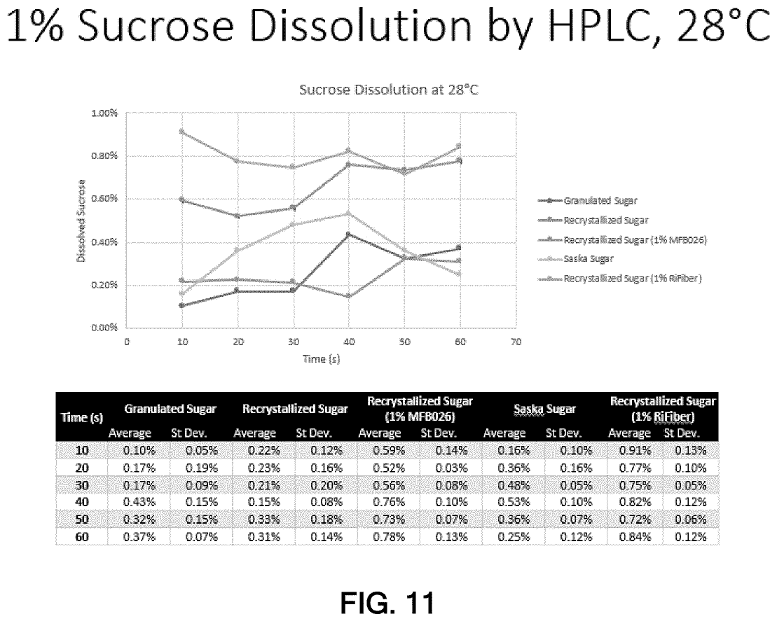

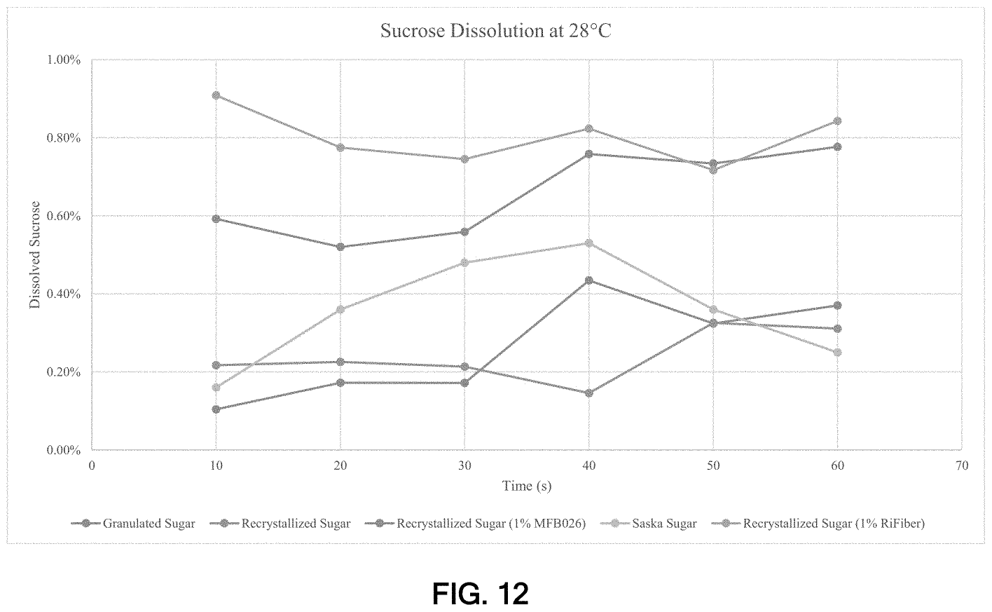

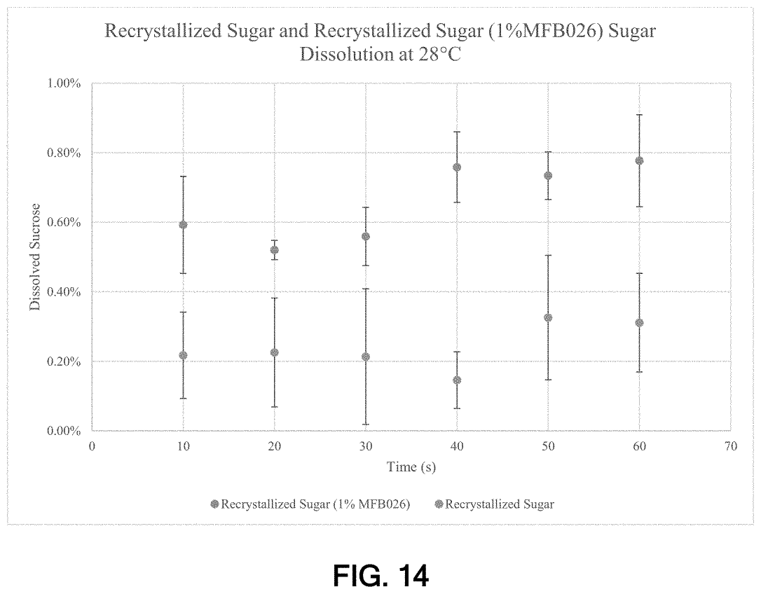

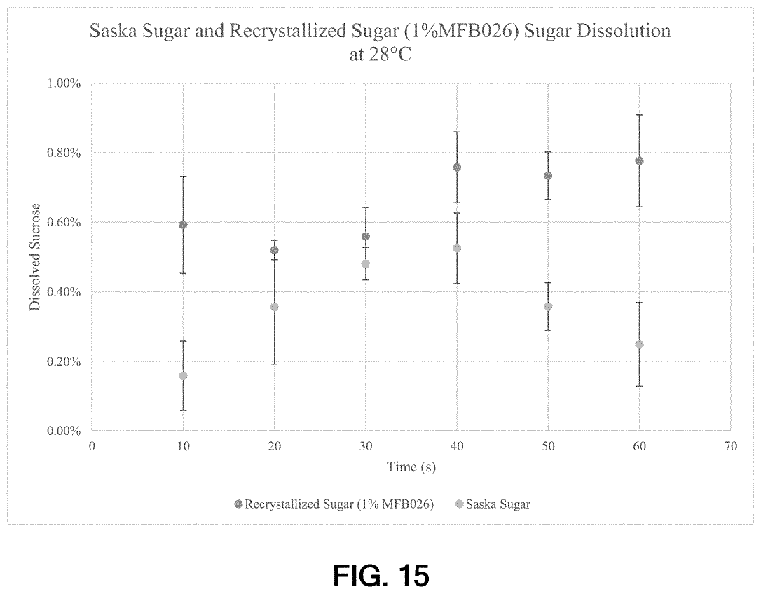

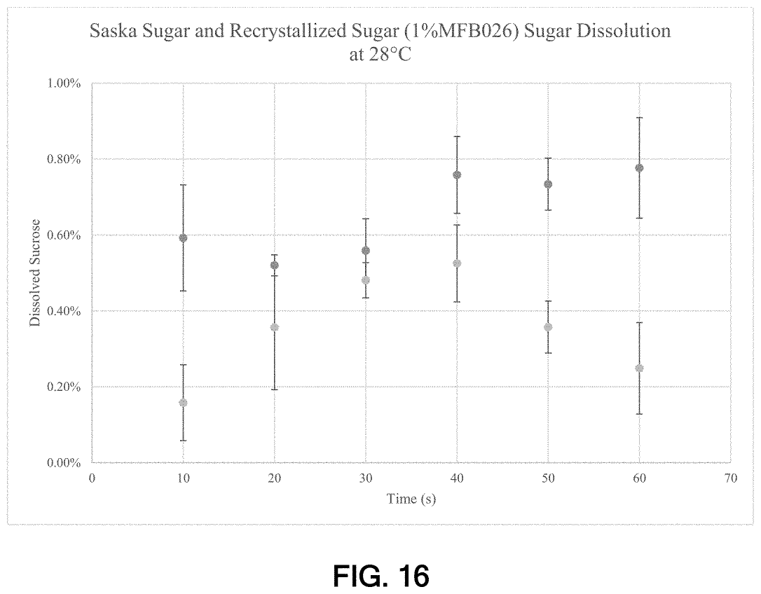

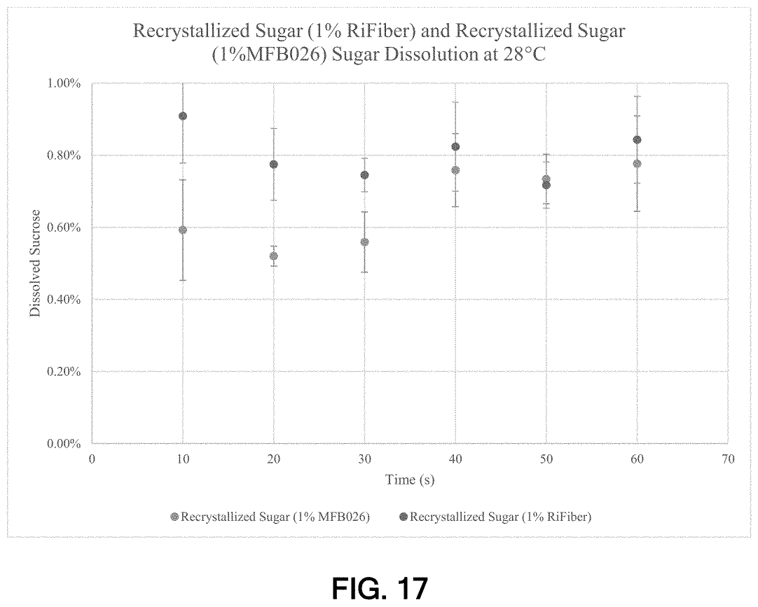

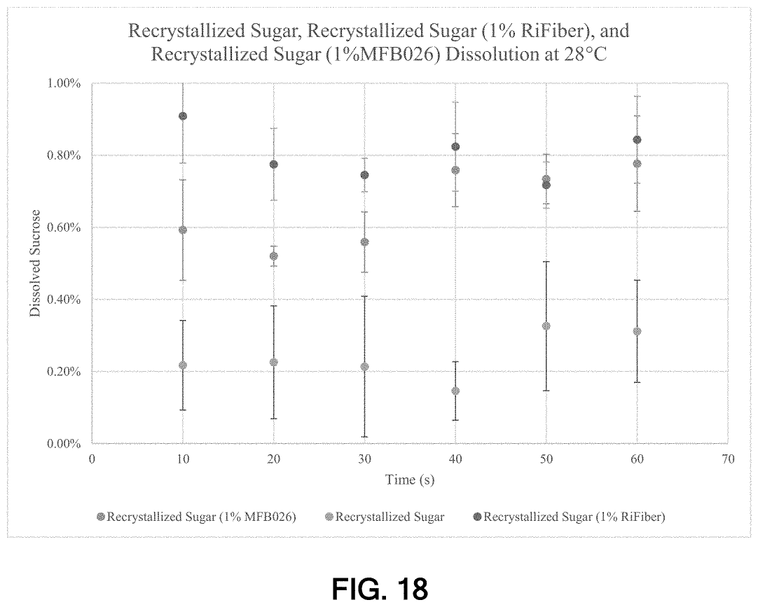

The dissolution results at 28° C. are shown in FIGS. 11-18.

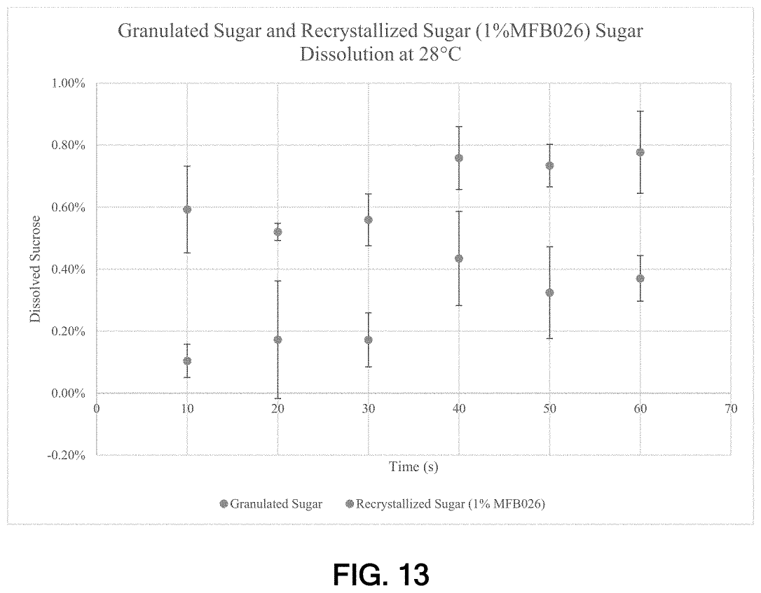

As shown in FIG. 13, for example, in the presence of the insoluble cellulose fiber as a nucleating agent, smaller crystals formed that, in turn, dissolved faster than larger crystals obtained in case of no nucleating agent (Recrystallized Sugar).

### Example 5—Particle Size Comparison

In Example 5, the same sugar samples analyzed in Example 4 were also analyzed using a Malvern Mastersizer 3000 to provide a particle size comparison.

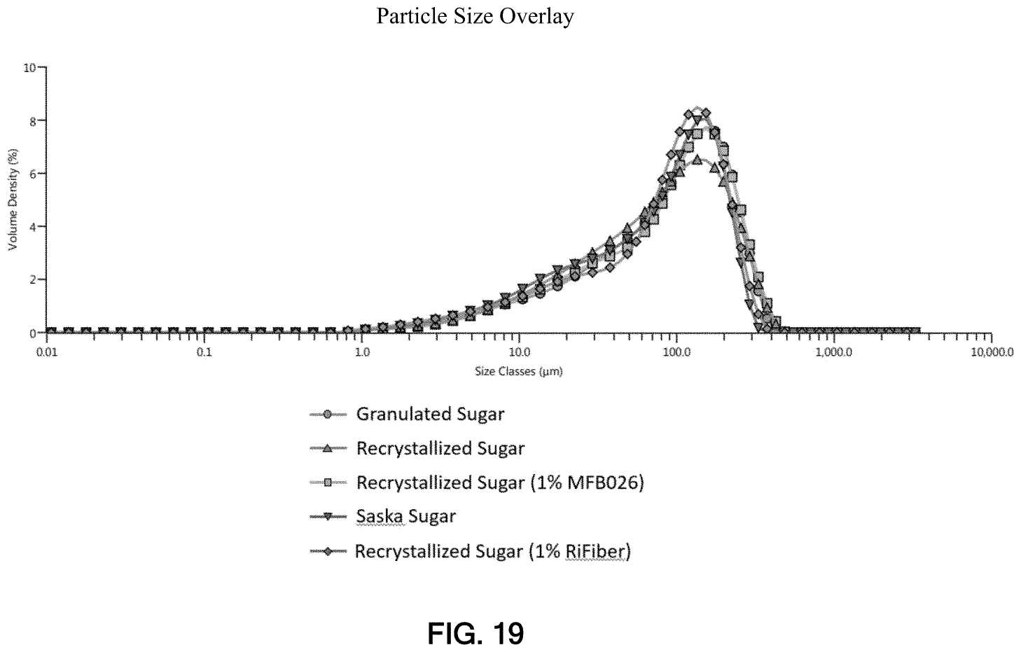

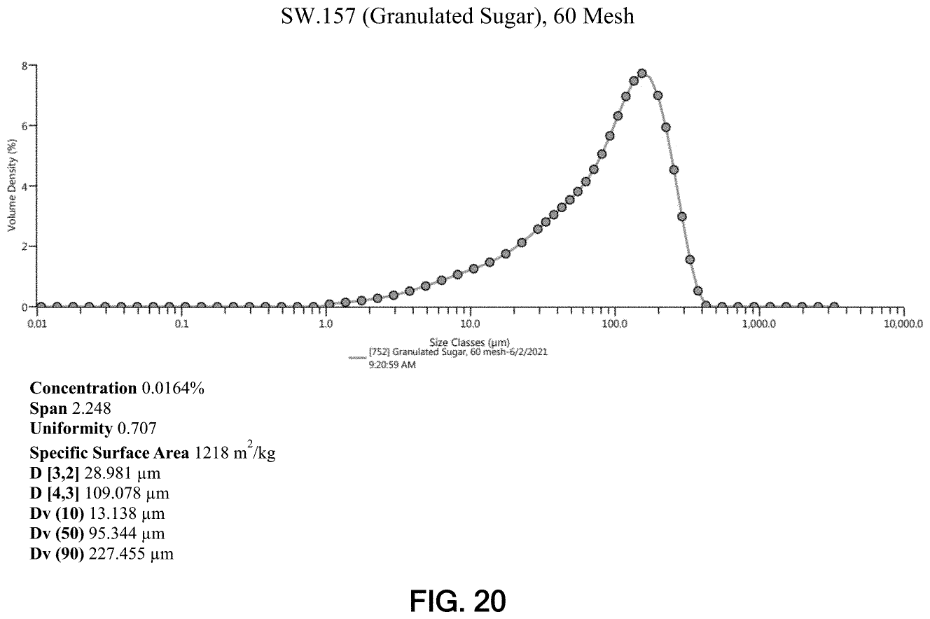

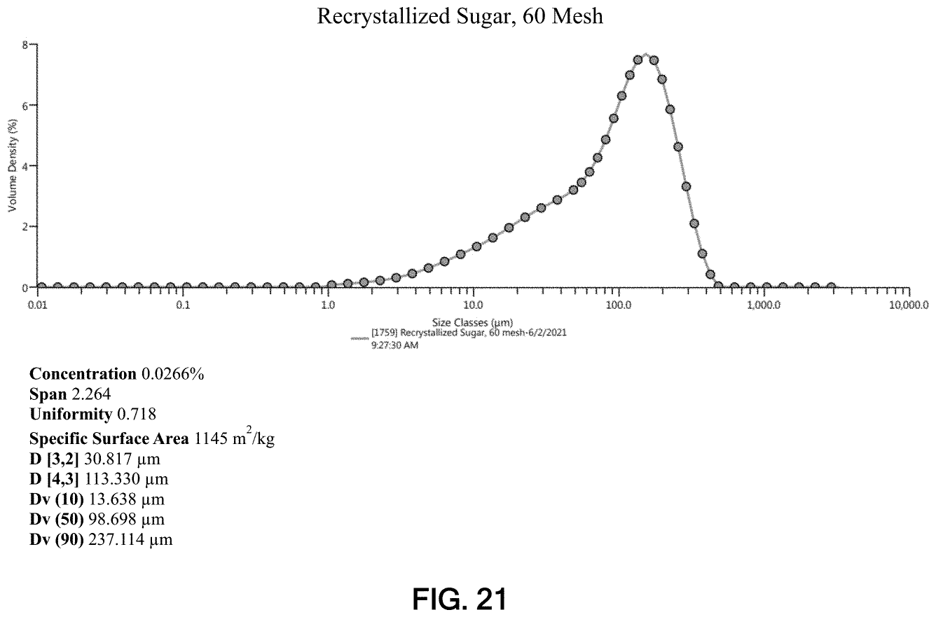

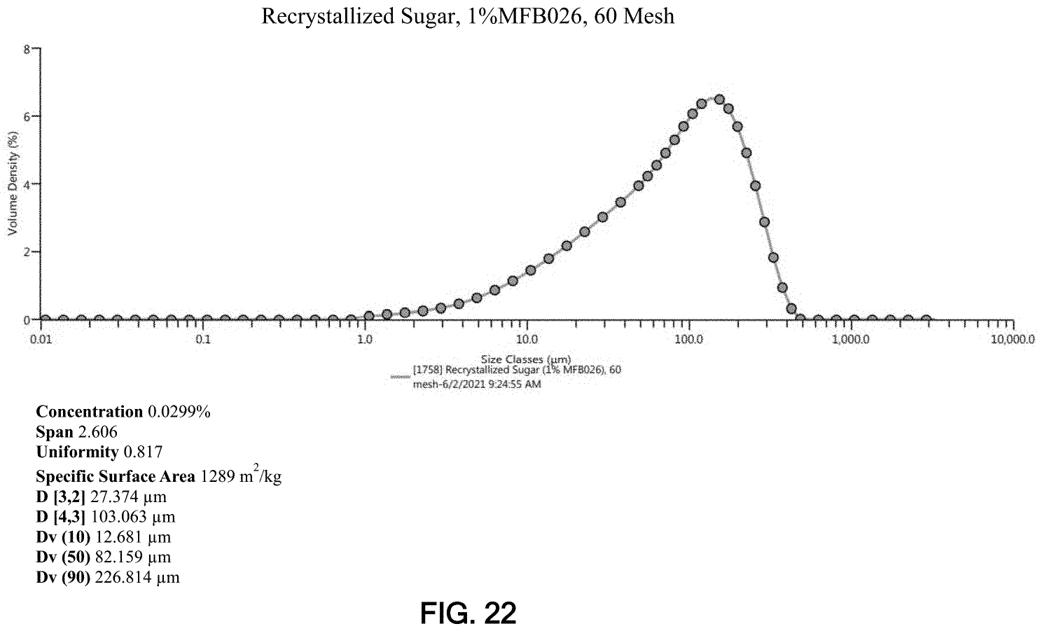

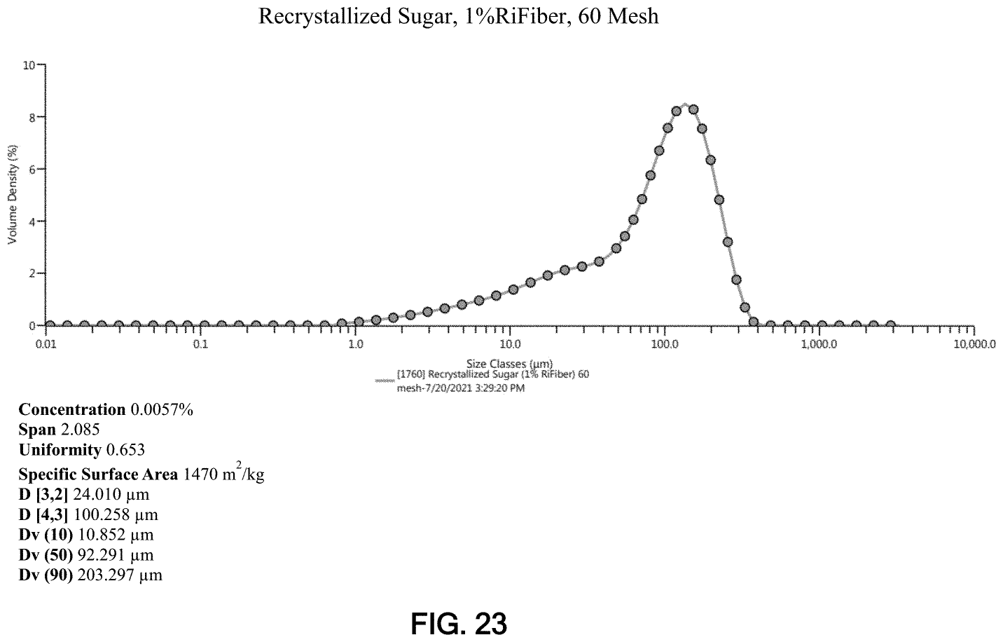

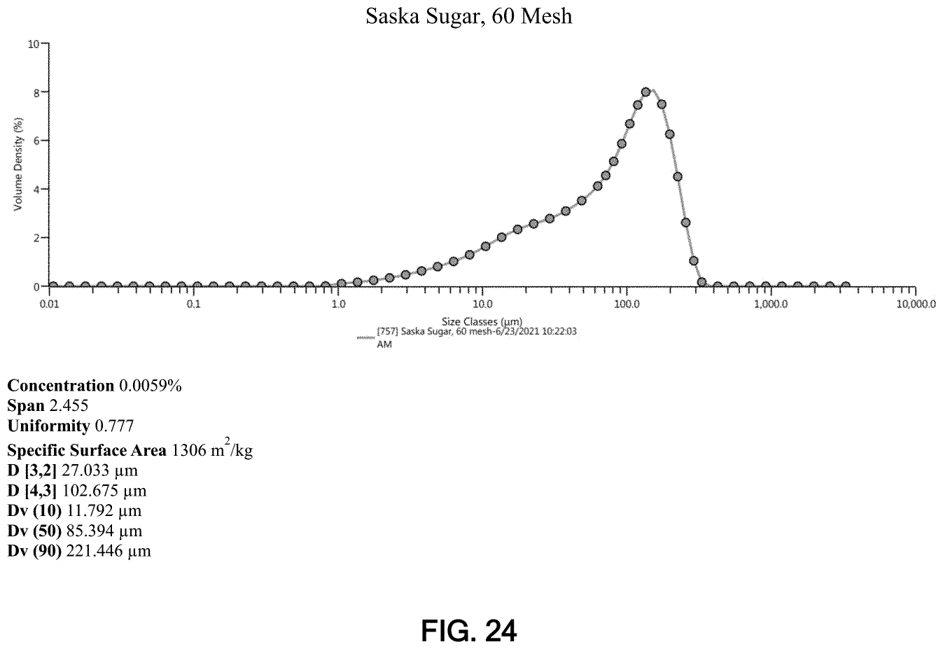

The particle size results are shown in FIGS. 19-24.

The particle size data shows, for example, that the use of the insoluble cellulose fiber (i.e., 1% MBF026 or 1% RiFiber) provide both large composite particles and small crystalline sugar particles that, in combination, reduce the median particle size of the obtained powder as compared to when no nucleating agent was used (e.g., the Recrystallized Sugar).

### Example 6—DSC Comparison

In Example 6, the same sugar samples analyzed in Example 4 (except for the Raspberry Crystalline Sugar, 1% RiFiber) were thermally analyzed by differential scanning calorimetry.

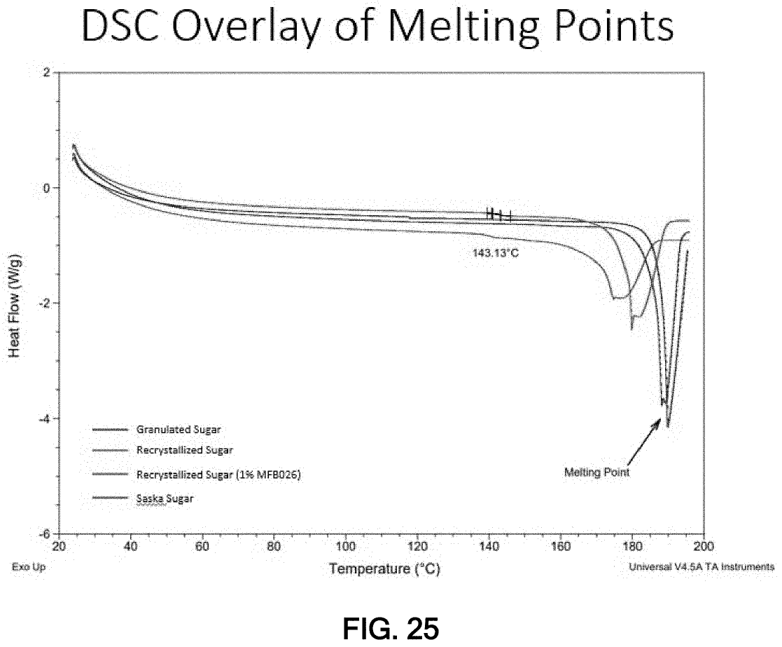

The DSC results are shown in FIG. 25.

As shown, for example, the Raspberry Crystalline Sugar, 1% MFB026 had the lowest melting point, demonstrating a faster dissolution than other types of sugars. This is consistent, for example, with the fact that a smaller particle size might be expected to melt faster on average.

### Comparative Example 3

The process of Example 1 was reproduced, except that 1 wt % of water insoluble silica nanoparticles having an average size of 500 um were used instead of the 1 wt % cellulose fiber. The silica particles were mixed with supersaturated solution of sugar; and then the mixture was poured into agitated methanol and maintained at 5° C. A white powder of crystalline sugar was obtained and sensory tests were performed. However, while a solid material was obtained, the results of the sensory data was that the product was entirely unacceptable.

While there have been shown and described fundamental novel features of the disclosure as applied to the preferred and exemplary embodiments thereof, it will be understood that omissions and substitutions and changes in the form and details of the disclosure may be made by those skilled in the art without departing from the spirit of the disclosure. Moreover, as is readily apparent, numerous modifications and changes may readily occur to those skilled in the art. For example, any feature(s) in one or more embodiments may be applicable and combined with one or more other embodiments. Hence, it is not desired to limit the present disclosure to the exact construction and operation shown and described and, accordingly, all suitable modification equivalents may be resorted to falling within the scope of the present disclosure as claimed. In other words, although the embodiments of the disclosure have been described with reference to the above examples, it will be understood that modifications and variations are encompassed within the spirit and scope of the disclosure. Accordingly, the invention is limited only by the following claims.

What is claimed is:

1. A crystalline sugar composite powder, comprising:
crystalline sugar particles, and
sugar composite particles,
wherein the crystalline sugar particles consist essentially of a sugar, and the crystalline sugar particles have a first average particle size,
wherein each of the sugar composite particles consist essentially of cellulose fiber and a plurality of sugar crystals formed on a surface of the cellulose fiber, the plurality of sugar crystals consist essentially of the sugar, and the sugar composite particles have a second average particle size,
wherein the first average particle size of the crystalline sugar particles is smaller than the second average particle size of the sugar composite particles.

2. The crystalline sugar composite powder according to claim 1, wherein the cellulose fiber is insoluble in water and methanol, but forms a dispersed suspension with agitation.

3. The crystalline sugar composite powder according to claim 1, wherein an average particle size of the crystalline sugar composite powder is 10 μm-250 μm.

4. The crystalline sugar composite powder according to claim 1, wherein the sugar is sucrose.

5. The crystalline sugar composite powder according to claim 1, wherein the second average particle size of the sugar composite particles is 1 μm-500 μm.

6. The crystalline sugar composite powder according to claim 1, wherein the first average particle size of the crystalline sugar particles is 0.5 μm to 100 um.

7. The crystalline sugar composite powder according to claim 1, wherein the crystalline sugar particles consist of the sugar.

8. The crystalline sugar composite powder according to claim 1, wherein the cellulose fiber is obtained from coffee beans, corn stalk, rice hull, wheat chaff, cauliflower floret, cauliflower stem, pea hull, soybean hull, cocoa hull, cabbage leaf, rice bran, corn bran, wheat bran, oat bran barley bran, rye bran, and millet bran.

9. The crystalline sugar-cellulose composite particles according to claim 1, wherein the cellulose fiber is natural cellulose fibers extracted from one or more selected from the group consisting of cereals, cabbage, fruits, legumes, nuts, grains, potatoes, and seeds.

10. The crystalline sugar-cellulose composite particles according to claim 1, wherein the cellulose fibers comprise lignin fibers, hemicellulose fibers, and/or pectin.

11. The crystalline sugar composite powder according to claim 1, wherein the cellulose fiber is obtained from spend coffee grounds.

12. The crystalline sugar composite powder according to claim 1, wherein the cellulose fiber has an average particle size of 10 μm to 120 μm.

13. The crystalline sugar composite powder according to claim 1, wherein a weight ratio of a total content of the cellulose to a total content of the sugar in the crystalline sugar composite powder is 0.1:99.9 to 20:80.

14. The crystalline sugar composite powder according to claim 1, wherein a moisture content of the crystalline sugar composite powder is less than 5% by weight.

15. The crystalline sugar composite powder according to claim 1, wherein the crystalline sugar composite powder is obtained by:
suspending the cellulose fiber in a supersaturated aqueous solution of the sugar;
reducing solubility of the sugar in the suspension with solvent inversion by mixing the suspension with a solvent having a temperature of −20 to 25° C. under stirring;
allowing a temperature of the mixture to rise;
separating resulting solids from supernatant; and
drying the separated resulting solids.

16. The crystalline sugar composite powder according to claim 1, wherein the crystalline sugar composite powder is obtained by:
suspending the cellulose fiber in a supersaturated aqueous solution of the sugar;
reducing solubility of the sugar in the suspension with solvent inversion by mixing the suspension with a solvent having a temperature of −10 to 10° C. under stirring;
allowing a temperature of the mixture to rise;
separating resulting solids from supernatant; and
drying the separated resulting solids.

17. A process of preparing a crystalline sugar composite powder, comprising:
suspending cellulose fiber in a supersaturated aqueous solution of a sugar, the resulting suspension having a temperature of from 5 to 60° C.;
adding a solvent having a temperature of from −20 to 25° C. to the resulting suspension and allowing a temperature of the resulting mixture to rise, thereby both precipitating a plurality of sugar crystals on a surface of the cellulose fiber to form a sugar composite particle, and precipitating a plurality of crystalline sugar particles;
separating a supernatant from solids; and
allowing the solids to dry to obtain the crystalline sugar composite powder.

18. The process according to claim 17, wherein
the resulting suspension has a temperature of from 15 to 40° C.; and
the temperature of the solvent added to the resulting suspension is from −10 to 10° C.

19. The process according to claim 17, wherein a content of the cellulose fibers in the sugar-cellulose suspension is 0.1 to 20% by weight.

20. The process according to claim 17, wherein the sugar is sucrose.

21. The process according to claim 17, wherein the allowing the temperature of the resultant to rise is performed by heating the resultant at a rate of 1 to 5° C. per minute.

22. The process according to claim 17, further comprising reducing a particles size of the crystalline sugar composite powder by grinding, crushing, and/or cutting.

23. The process according to claim 17, wherein the step of allowing the solids to dry is performed by heating the solids at temperature of 50 to 80° C.

24. The process according to claim 17, wherein the solvent comprises methanol.

25. A food, comprising the crystalline sugar composite powder according to claim 1, wherein the food is selected from the group consisting of baked goods, confections, oil-based systems such as chocolate, oil based sauces, creams, butters, low water food items such as cookies, granola bars.
